(19) United States
(12) Patent Application Publication
(10) Pub. No.: US 2009/0324326 A1
(43) Pub. Date: Dec. 31, 2009

(54) Anti-loosing socket adapter

(75) Inventor: Shu-Wen Lin, Taichung Hsien (TW)

Correspondence Address: CHARLES E. BAXLEY, ESQUIRE, 90 JOHN STREET, SUITE 309, NEW YORK, NY, 10038, US

(73) Assignee: Forging Adapter Co., Ltd.

(21) Appl. No.: 12/215,775

(22) Filed: Jun. 30, 2008

(51) Int. Cl. B25G 3/18

(52) U.S. Cl. 403/322.2; 403/327

(57) ABSTRACT

An anti-loosing quick-release socket adapter, being easy to produce, having enhanced durability, providing improved stability when combined with a close-end wrench, comprises a hexagonal connecting portion whereon an annular groove is formed with a positioning hole so that a flexible metal wire is fittingly received and positioned in the groove. The metal wire is preformed into a predetermined curved shape and includes two bent segments jutting out a periphery of the hexagonal connecting portion.

### BACKGROUND OF THE INVENTION

1. Technical Field

The present invention relates to hand tools, and more particularly, to an anti-loosing quick-release socket adapter.

2. Description of Related Art

A quick-release socket adapter is used with for easily assembling with a closed-end wrench and assisting the wrench in driving fastening components with various dimensions. Therein, the closed-end wrench may be a ring spanner or a ratchet wrench. Please refer to FIGS. 1 and 2. A conventional quick-release socket adapter 800 primarily has a hexagonal connecting portion 801 and a socket portion 802. The hexagonal connecting portion 801 is designed to match an inner driving periphery of a commercially available closed-end wrench while the socket portion 802 has a quick-release ball assembly 8021 for facilitating combination between the socket portion 802 and an external fastening component. In this prior art device, the hexagonal connecting portion 801 is milled with an annular groove 8011 adjacent to a top thereof for fittingly receiving an inner periphery of a plastic O-ring 8012 so that the O-ring 8012 has its outer periphery slightly raised from an outer periphery of the hexagonal connecting portion 801. The O-ring 8012 serves to provide bidirectional pressing forces to the connecting portion 801 and an inner driving periphery of a closed-end wrench that is combined with the connecting portion 801 so as to position the connecting portion 801 in the inner driving periphery of the closed-end wrench. However, the plastic O-ring 8012 tends to lose its resilience due to material aging with frequent engagement and disengagement between the connecting portion 801 and plural closed-end wrenches. Eventually, once the plastic O-ring 8012 becomes inflexible or even broken or deformed, it fails to stably position the connecting portion 801 with respect to a closed-end wrench, resulting in an inferior durability that is economically disadvantageous.

Please refer to FIGS. 3 and 4 for Taiwan Patent No. I271279, a positioning assembly of a hand tool, which also refers to a socket adapter 900 primarily having a hexagonal connecting portion 901 milled with a groove 9011 and a socket portion 902. This prior art device is different from the previous one at that the groove 9011 receives a flexible metal wire 9012 bent into a predetermined curved shape instead of an O-ring. The groove 9011 includes at least one straight segment 90111 for matching a straight segment 90121 of the metal wire 9012 installed therein so that bent segments 90122 of the metal wire 9012 jut out an outer periphery of the hexagonal connecting portion 901, thereby providing a pressing force between the socket adapter 900 and an inner driving periphery 910 of a closed-end wrench that is combined with the connecting portion 901. Though such prior art device surpasses the previous one using an O-ring in durability, it still has some defects. First, for positing the flexible metal wire 9012 in the groove 9011, the groove 9011, which was firstly milled and having an semicircular bottom, has to be further processed for the straight segment 09111 fitting the straight segment 90121 of the metal wire 9012, resulting in increased processing costs. Besides, since the metal wire 9012 is positioned in the groove 9011 only relying on the linear constriction between the straight segments 09111 and 90121, it tends to shift along the groove 9011 when being compressed by an inner driving periphery 910 of a closed-end wrench that is combined with the connecting portion 901. While the bent segments 90122 of the metal wire 9012 are not necessarily engaged with splines 9101 of the inner driving periphery 910 of the closed-end wrench, the metal wire 9012 and the inner driving periphery 910 only have spot connections that are weak in positioning the socket adapter 900 with respect to the closed-end wrench. Therefore, those conventional positioning means of the known socket adapters need to be improved.

### SUMMARY OF THE INVENTION

In view of the shortcomings of the prior art devices, the present invention herein provides an anti-loosing quick-release socket adapter, being easy to produce, having enhanced durability, providing improved stability when combined with a close-end wrench.

The anti-loosing quick-release socket adapter comprises a hexagonal connecting portion and a socket portion that is provided with a quick-release ball positioning assembly for combining an external fastening component. An annular groove is formed at a periphery of the hexagonal connecting portion while being adjacent to a top of the hexagonal connecting portion. A positioning hole is perpendicularly formed at a bottom of the groove and a flexible metal wire is fittingly received in the groove. The metal wire is formed into a predetermined curved shape that includes successively a hook portion, a first straight segment, a first bent segment, a second straight segment, a second bent segment and a third straight segment. The hook portion is engaged with the positioning hole of the hexagonal connecting portion so that the first, second and third straight segments connect the bottom of the groove, while the first and second bent segments jut out the periphery of the hexagonal connecting portion.

According to the above structure, the present invention has the following advantages.

First, the bent segments of the flexible metal wire serve to fasten the socket adapter with an external wrench on the strength of its resilience while contributing an enhanced durability to the socket adapter by replacing the plastic O-ring that is used in the prior art device and subject to material aging problem.

Second, the positioning hole at the hexagonal connecting portion serves to position the flexible metal wire so as to prevent the metal wire from randomly shifting along the groove when the socket adapter is assembled with or disassembled from an external wrench, thereby improving stability of the combination between the socket adapter and the wrench.

Third, the positioning hole at the hexagonal connecting portion serves to position the flexible metal wire so as to dispense with the straight segment of the groove processed at the bottom of the groove of the prior art device so as to simplify manufacturing procedures and thereby reduce manufacturing costs.

Fourth, when the positioning assembly is engaged with an external wrench, the bent segments of the metal wire right fit two splines of an inner driving periphery of the wrench, thereby further improving stability of the combination between the socket adapter and the wrench.

Fifth, since the bent segments of the metal wire are positioned with respect to the hexagonal connecting portion due to the positioning hole and the bent segments are engaged with two splines of an inner driving periphery of the wrench, the join counterforce from the inner driving periphery of the wrench against the two bent segments acts on an opposite edge of the hexagonal connecting portion so that two vertexes of the edge are firmly pressed into corresponding splines of the inner driving periphery of the wrench, thereby achieving a four-point positioning effect and even further improving stability of the combination between the socket adapter and the wrench.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is an exploded view of a conventional socket adapter using a plastic O-ring;

FIG. 2 is a cross-sectional view of the conventional socket adapter of FIG. 1;

FIG. 3 is an exploded view of a conventional socket adapter using a flexible metal wire;

FIG. 4 is a cross-sectional view of the conventional socket adapter of FIG. 3;

FIG. 5 is an exploded view of a quick-release socket adapter having the disclosed positioning assembly according to the present invention;

FIG. 6 is a cross-sectional view of the socket adapter of FIG. 5 according to the present invention;

FIG. 7 is another cross-sectional view of the socket adapter of FIG. 5 according to the present invention;

FIG. 8 is a schematic drawing showing the socket adapter of the present invention to be assembled with a closed-end wrench; and

FIG. 9 is a schematic drawing showing the socket adapter of the present invention is assembled with the closed-end wrench.

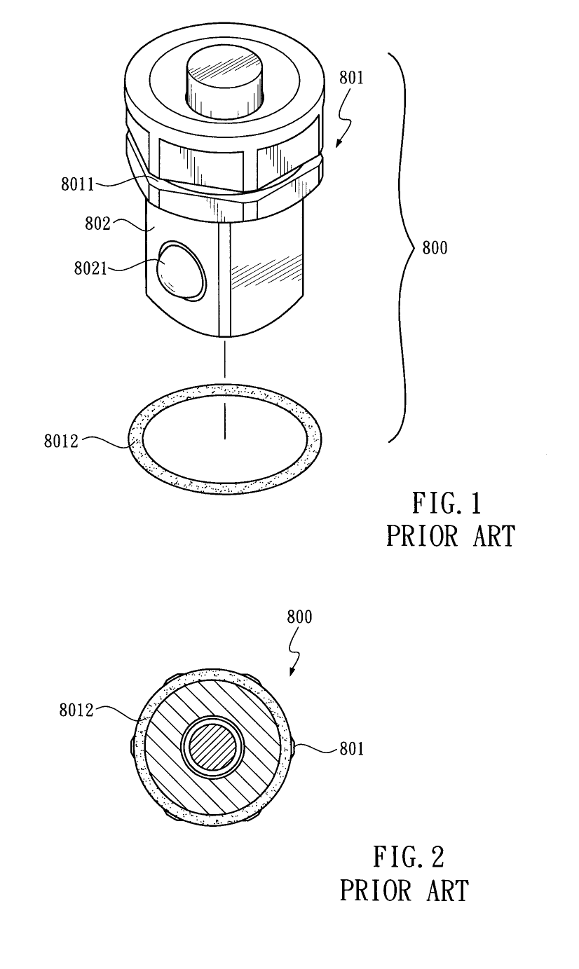

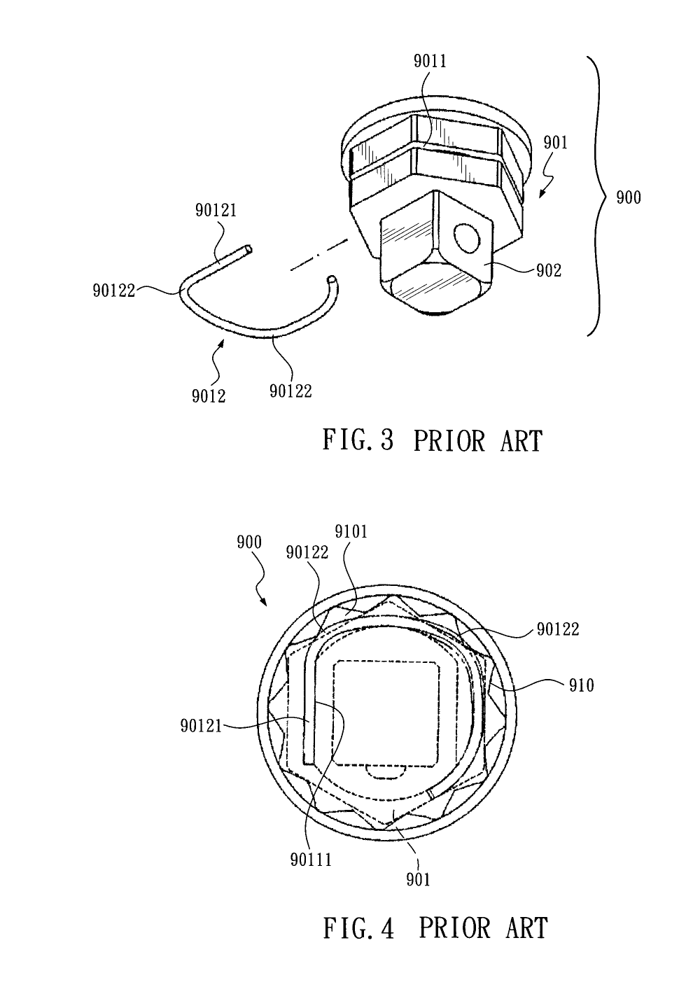

### DETAILED DESCRIPTION OF THE PREFERRED EMBODIMENT

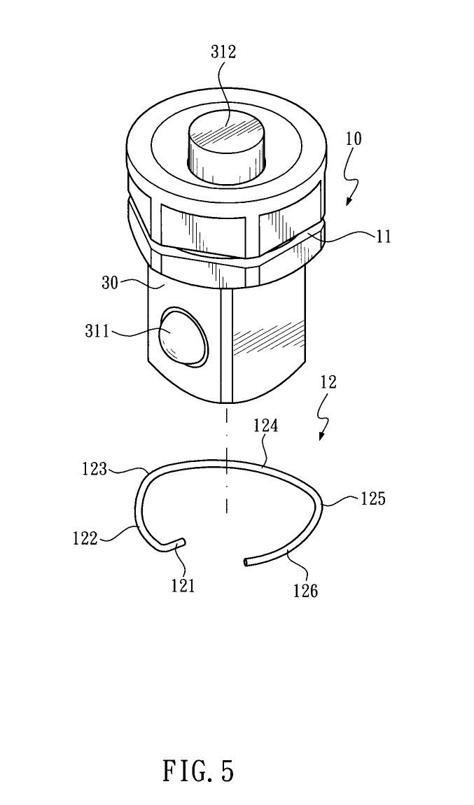

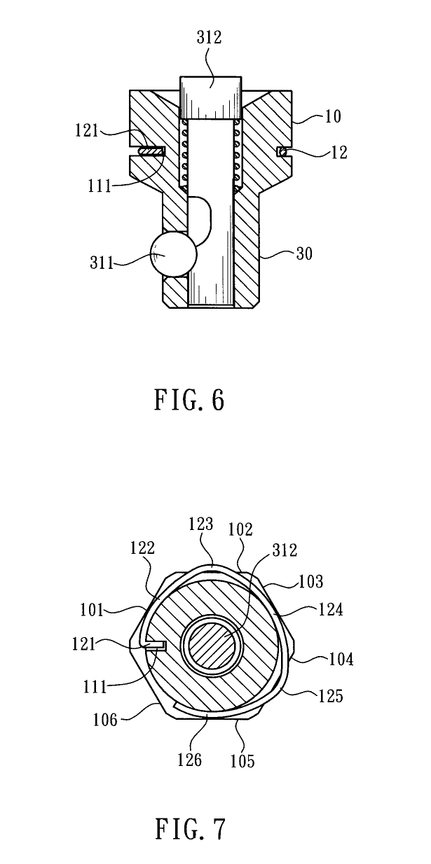

Please refer to FIGS. 5 through 7 for one embodiment of an anti-loosing quick-release adapter of the present invention. As shown in FIG. 5, the quick-release socket adapter comprises a hexagonal connecting portion 10 and a socket portion 30. The hexagonal connecting portion 10 has six equalized edges and an outer periphery matching an inner driving periphery of a commercially available closed-end wrench while the socket portion 30 has an outer periphery matching an inner periphery of a commercially available fastening component. Besides, the socket portion 30 is provided with a quick-release ball assembly for being engaged with one said fastening component. The quick-release ball assembly comprises a ball 311 movably raised from the periphery of the socket portion 30 and a pressing button 312 movably raised from a top of the hexagonal connecting portion 10, wherein the ball 311 is controlled to be raised from or sunk into the periphery of the socket portion 30 by pressing the pressing button 312 so as to facilitate the socket adapter being assembled with or disassembled from an external fastening component.

An annular groove 11 is formed at the periphery of the hexagonal connecting portion 10 while being adjacent to the top of the hexagonal connecting portion 10. A positioning hole 111 is perpendicularly formed at a bottom of the groove 11 and a flexible metal wire 12 is fittingly received in the groove 11. Therein, the flexible metal wire 12 is preformed into a predetermined curved shape. The predetermined curved shape includes successively a hook portion 121, a first straight segment 122, a first bent segment 123, a second straight segment 124, a second bent segment 125 and a third straight segment 126.

Herein, for the convenience of illustration, the six edges of the hexagonal connecting portion 10 are defined as a first edge 101, a second edge 102, a third edge 103, a fourth edge 104, a fifth edge 105 and a sixth edge 106. Meanwhile, it is assumed that the positioning hole 111 is located at a border between the first edge 101 and the sixth edge 106 of the hexagonal connecting portion 10.

Therefore, as can be seen in FIG. 7, when the flexible metal wire 12 installed in the groove 11 with the hook portion 121 retained in the positioning hole 111, the first straight segment 122, second straight segment 124, and third straight segment 126 partially abuts against the first edge 101, the third edge 103, and the fifth edge 105, respectively, while the first bent segment 123 and the second bent segment 125 jut out the second edge 102 and the fourth edge 104, respectively.

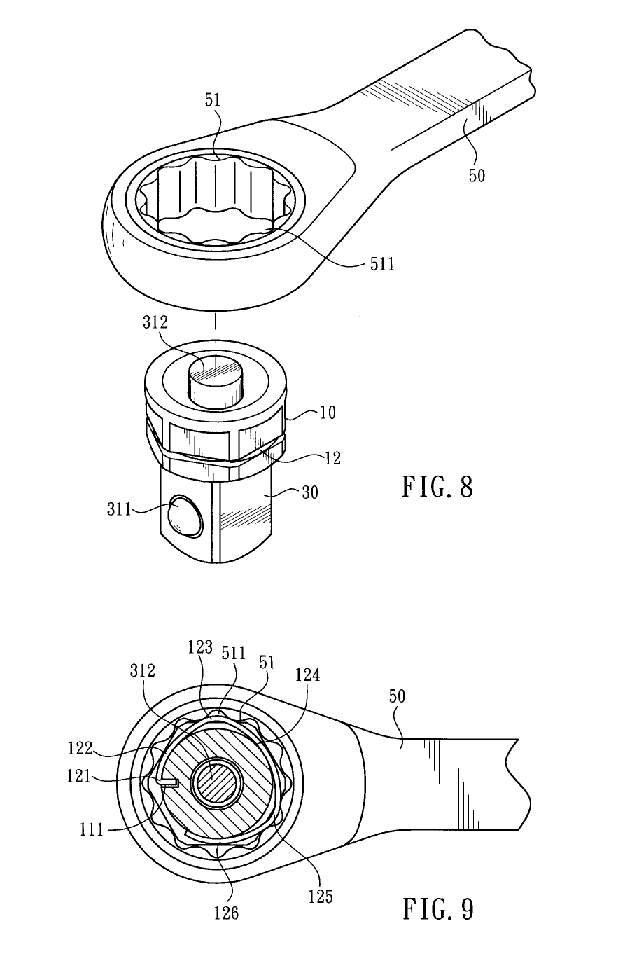

According to the above-described configuration, the flexible metal wire 12 is further defined as a fixed end while an extreme of the third straight segment 126 is further defined as a free end. Thus, when the bent segments 123, 125 of the flexible metal wire 12 affixed to the hexagonal connecting portion 10 receive an incoming centripetal pressure, the free end shifts toward the fixed end where the hook portion 121 is located along the groove 11, so that the bent segments 123, 125 retract and no more jut out the second edge 102 and the fourth edge 104 of the hexagonal connecting portion 10, thereby facilitating combination of the socket adapter and a closed-end wrench 50. After the socket adapter and the closed-end wrench 50 are combined, the bent segments 123, 125 of the flexible metal wire 12 resile and again jut out the second edge 102 and the fourth edge 104 of the hexagonal connecting portion 10 so as to fittingly abut corresponding splines 511 of an inner driving periphery of the closed-end wrench 50, thereby improving stability of the combination between the socket adapter and the wrench 50, as shown in FIGS. 8 and 9.

At this moment, the join counterforce from the inner driving periphery of the wrench 50 against the two bent segments 123, 125 acts on the of the sixth edge 106 of the hexagonal connecting portion 10 so that two vertexes of the sixth edge 106 are firmly pressed into corresponding splines of the inner driving periphery of the wrench 50, thereby achieving a four-point positioning effect and even further improving stability of the combination between the socket adapter and the wrench.

Although the particular embodiment of the invention has been described in detail for purposes of illustration, it will be understood by one of ordinary skill in the art that numerous variations will be possible to the disclosed embodiments without going outside the scope of the invention as disclosed in the claims.

What is claimed is:

1. An anti-loosing quick-release socket adapter, comprising a hexagonal connecting portion and a socket portion, wherein the hexagonal connecting portion is to be engaged with a closed-end wrench and the socket portion is to be engaged with a fastening component, the anti-loosing quick-release socket adapter being characterized in,
having an annular groove formed at a periphery of the hexagonal connecting portion while being adjacent to a top of the hexagonal connecting portion, a positioning hole perpendicularly formed at a bottom of the groove and a flexible metal wire fittingly received in the groove, wherein the metal wire includes successively a hook portion, a first straight segment, a first bent segment, a second straight segment, a second bent segment and a third straight segment so that when the metal wire is installed in the groove and the hook portion is engaged with the positioning hole of the hexagonal connecting portion, the first and second bent segments jut out the periphery of the hexagonal connecting portion.

2. The anti-loosing quick-release socket adapter of claim 1, wherein the hexagonal connecting portion includes a first edge, a second edge, a third edge, a fourth edge, a fifth edge and a sixth edge while the positioning hole is located at a border between the first and sixth edges, whereby, when the e metal wire is installed in the groove, the first and second bent segments jut out the second edge and the fourth edge of the hexagonal connecting portion, respectively.

3. The anti-loosing quick-release socket adapter of claim 1, wherein the closed-end wrench is an offset ring spanner.

4. The anti-loosing quick-release socket adapter of claim 1, wherein the closed-end wrench is a ratchet wrench.
